(19) United States
(12) Patent Application Publication
(10) Pub. No.: US 2025/0095945 A1
(43) Pub. Date: Mar. 20, 2025

(54) ELECTRON GUN AND VACUUM ELECTRONIC DEVICE

(71) Applicant: Huawei Technologies Co., Ltd., Shenzhen (CN)

(72) Inventors: Jie Xie, Shenzhen (CN); Qianfu Cheng, Chengdu (CN)

(21) Appl. No.: 18/968,571

(22) Filed: Dec. 4, 2024

Related U.S. Application Data
(63) Continuation of application No. PCT/CN2023/096423, filed on May 26, 2023.

(30) Foreign Application Priority Data
Jun. 6, 2022 (CN) 202210634919.0

(51) Int. Cl. H01J 23/06; H01J 23/087; H01J 23/14; H01J 25/34

(52) U.S. Cl. CPC H01J 23/06; H01J 23/087; H01J 23/14; H01J 25/34

(57) ABSTRACT

Example electron gun, vacuum device, and system are provided. An example electron gun includes a cathode, a focus electrode, and an energy exchange module. The energy exchange module includes an anode port, a signal input port, and an energy exchange unit. An input signal is input from the signal input port of the energy exchange module into the energy exchange unit of the energy exchange module, and energy exchange with the input signal is performed by transmitting an electron beam from the anode port of the energy exchange module to the energy exchange unit of the energy exchange module. The electron beam is generated by the cathode, the focus electrode, and the anode port.

### CROSS-REFERENCE TO RELATED APPLICATIONS

This application is a continuation of International Application No. PCT/CN2023/096423, filed on May 26, 2023, which claims priority to Chinese Patent Application No. 202210634919.0, filed on Jun. 6, 2022. The disclosures of the aforementioned applications are hereby incorporated by reference in their entireties.

### TECHNICAL FIELD

This disclosure relates to the field of communication technologies, and more specifically, to an electron gun and a vacuum electronic device.

### BACKGROUND

As a core device of a radar electronic system, a communication electronic system, or another electronic system, a vacuum electronic device (for example, a traveling wave tube, a klystron, a backward wave tube, or a gyrotron) used in a microwave band, a millimeter-wave band, a terahertz band, or another frequency band is currently developing towards miniaturization and integration. As a core component of the vacuum electronic device, an electron gun is mainly configured to generate an electron source that can meet an operating requirement of the vacuum electronic device.

An existing vacuum electronic device basically uses a form in which an electron gun and a high-frequency signal input system are separately designed, that is, uses a form in which the electron gun and the high-frequency signal input system are separately equipped and then welded and sealed. This causes a complex structure, a large volume, and a large assembly error of the vacuum electronic device, and is not conducive to miniaturization development of the vacuum electronic device.

### SUMMARY

This disclosure provides an electron gun and an electronic device. An anode and a signal input system of the electron gun are integrated into one assembly, so that an integrated design and processing and manufacturing of the electron gun and the signal input system can be implemented. In addition, because an integrated design form of the electron gun and the signal input system is used, in this disclosure, a length of a circuit in which energy exchange occurs between an electron beam and a high-frequency circuit can be reduced, and energy exchange efficiency between the electron beam and the high-frequency circuit can be improved.

According to a first aspect, an electron gun is provided. The electron gun includes a cathode, a focus electrode, and an energy exchange module. The energy exchange module includes an anode port, a signal input port, and an energy exchange unit. An input signal is input from the signal input port of the energy exchange module into the energy exchange unit of the energy exchange module, and an electron beam is transmitted from the anode port of the energy exchange module to the energy exchange unit of the energy exchange module to perform energy exchange with the input signal. The electron beam is generated by the cathode, the focus electrode, and the anode port.

The anode and the signal input port (where the signal input port may also be understood as a signal input system) of the electron gun are integrated together (for example, into an energy exchange module 33), so that an integrated design and processing and manufacturing of the electron gun and the signal input system can be implemented. In addition, because an integrated design form of the electron gun and the signal input system is used, in this disclosure, a distance over which energy exchange occurs between the electron beam and the high-frequency circuit can be reduced, and energy exchange efficiency between the electron beam and the high-frequency circuit can be improved.

In some embodiments, the energy exchange unit includes a resonant cavity.

In this way, in this embodiment of this disclosure, a high resonance characteristic of the resonant cavity may be used, to enhance a modulation capability for the electron beam.

In some embodiments, the energy exchange unit includes at least one of the following: a slow-wave circuit or at least two resonant sub-cavities.

Specifically, in this embodiment of this disclosure, the resonant cavity or the slow-wave circuit may be used to generate an axial electromagnetic field, and the axial electromagnetic field may be used to complete velocity modulation for the electron beam, so that energy exchange efficiency between the electron beam and the input signal can be improved.

In some embodiments, the electron gun further includes a probe. The probe extends into the energy exchange unit from the signal input port.

The probe is used to achieve a more compact structure and a smaller size. A probe-based coupling is an electrical coupling. The probe is inserted into the resonant cavity in a direction parallel to a power line of a high-frequency electric field, so that the electric field induces a high-frequency potential as high as possible on the probe, to enhance the modulation capability for the electron beam.

In some embodiments, a length at which the probe extends into the energy exchange unit from the signal input port is determined based on the energy exchange unit.

Specifically, the probe is inserted in a direction parallel to a power line of a high-frequency electric field. Preferably, the probe should be located at a position in which the high-frequency electric field is concentrated in a circuit. This may be specifically determined based on an operating mode of the circuit.

The length at which the probe extends into the energy exchange unit is determined based on the energy exchange unit. In this way, the electromagnetic field can induce the high-frequency potential as high as possible on the probe, to enhance the modulation capability for the electron beam.

In some embodiments, the electron gun further includes a coupling loop. The coupling loop is separately in contact with the probe and the energy exchange unit.

The coupling loop is used, and a plane of the coupling loop is perpendicular to a magnetic line of a high-frequency magnetic field. In this way, as many magnetic lines as possible can pass through the coupling loop, to induce a high-frequency current.

In some embodiments, the probe and the coupling loop are made of a same material.

In some embodiments, the electron gun further includes a cathode base, an insulating sleeve, and a support rod. The support rod is configured to connect the focus electrode to the insulating sleeve; and the cathode base is connected to the insulating sleeve.

In some embodiments, the electron gun further includes an electron beam output port. The electron beam output port is provided on the energy exchange unit.

Specifically, the electron beam output port is configured to output the electron beam, and may be further configured to be welded with a subsequent high-frequency circuit, and so on.

In some embodiments, the electron gun further includes a sealing unit. The sealing unit is disposed on the signal input port; and the probe extends from the sealing unit into the energy exchange unit.

Specifically, the sealing unit may be configured to ensure vacuum sealing of the electron gun, and may be further configured to ensure that the input signal can be input into the energy exchange unit.

In some embodiments, the anode port, the signal input port, and the energy exchange unit are made of a same material.

In some embodiments, the anode port, the signal input port, and the energy exchange unit are integrally processed and molded.

In some embodiments, the energy exchange unit is made of silver or copper; or an inner wall of the energy exchange unit is plated with silver or copper.

In some embodiments, the anode port is made of silver or copper; or a surface of the anode port is plated with silver, copper, or molybdenum.

According to a second aspect, a vacuum electronic device is provided. The vacuum electronic device includes the electron gun according to any one of the first aspect or the embodiments of the first aspect.

In some embodiments, the vacuum electronic device further includes a magnetic focus system, a collector, and an output energy coupler.

In some embodiments, the vacuum electronic device further includes an attenuator.

### BRIEF DESCRIPTION OF DRAWINGS

FIG. 1 is a diagram of an application scenario according to an embodiment of this disclosure;

FIG. 2 is a diagram of a structure of a traveling wave tube 200;

FIG. 3 is a diagram of a structure of an electron gun 300 according to an embodiment of this disclosure;

FIG. 4 is a diagram of a structure of an electron gun 400 according to an embodiment of this disclosure;

FIG. 5 is a diagram of a structure of a signal input port 500 according to an embodiment of this disclosure;

FIG. 6 is a diagram of a structure of an energy exchange unit 600 according to an embodiment of this disclosure; and

FIG. 7 is a diagram of a structure of a vacuum electronic device 700 according to an embodiment of this disclosure.

### DETAILED DESCRIPTION OF ILLUSTRATIVE EMBODIMENTS

The following describes technical solutions of this disclosure with reference to the accompanying drawings.

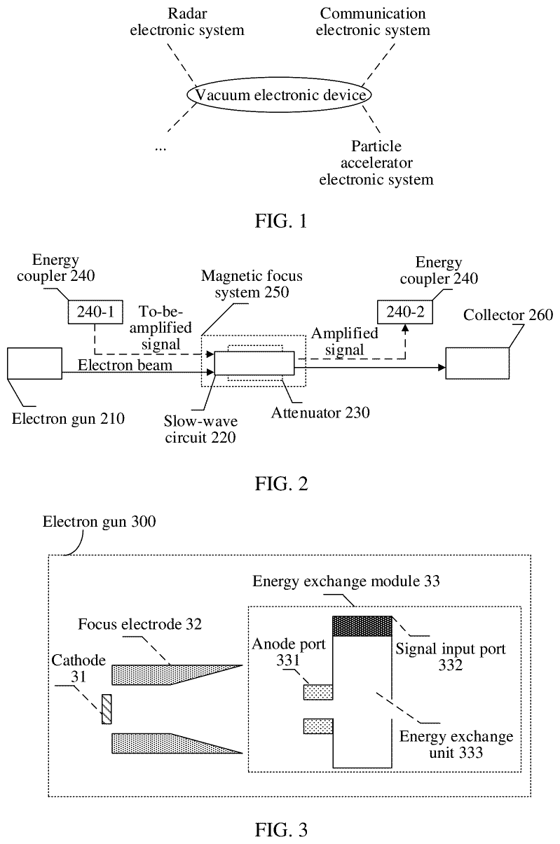

As a device capable of implementing functions such as power amplification and oscillation, a vacuum electronic device can be widely used in many fields. For details, refer to FIG. 1.

FIG. 1 is a diagram of an application scenario according to an embodiment of this disclosure. As shown in FIG. 1, a vacuum electronic device can be used in a radar electronic system, a communication electronic system, a particle accelerator electronic system, or another electronic system, and is used as an indispensable core device in the foregoing electronic system. For example, in the communication electronic system, the vacuum electronic device may be used as an oscillator and an amplifier. In a radar system, the vacuum electronic device may be used as a receiver and a transmitter, and a signal source of an active phased array antenna. In addition, in an information system, the vacuum electronic device may be used as a transmitting source for broadcast television and a television station, a transponder for microwave communication and satellite communication, and a base station in mobile communication. In addition, the vacuum electronic device may be used as a signal source in a millimeter wave and terahertz imaging system, nondestructive testing, a biomedical system, and a security inspection system, a signal source for plasma diagnosis and heating, and a high-power microwave source in a controllable thermonuclear reaction.

The vacuum electronic device may be used in a microwave band, a millimeter-wave band, a terahertz band, or another frequency band. There are various types of vacuum electronic devices, for example, including different types such as a traveling wave tube, a klystron, a gyrotron, a backward wave tube, and a magnetron.

In a structural composition of the vacuum electronic device, as a core component of the vacuum electronic device (for example, the traveling wave tube), an electron gun may generate an electron beam having a specified size and current, and can accelerate the electron beam to a velocity slightly higher than that of an electromagnetic wave (which may be understood as an input signal) traveling on a slow-wave circuit, to exchange energy with the electromagnetic wave, so as to implement an amplification or oscillation function of a signal.

An existing vacuum electronic device basically uses a form in which the electron gun and a high-frequency signal input system are separately designed, that is, uses a form in which the electron gun and the high-frequency signal input system are separately equipped and then welded and sealed. This causes a complex structure, a large volume, and a large assembly error of the vacuum electronic device, and is not conducive to miniaturization development of the vacuum electronic device. For details, refer to FIG. 2.

For ease of description, the following uses a traveling wave tube in the vacuum electronic device as an example for description. However, this description manner cannot limit the protection scope required by this disclosure.

FIG. 2 is a diagram of a structure of a traveling wave tube 200. As shown in FIG. 2, the traveling wave tube 200 includes an electron gun 210, a slow-wave circuit 220, an attenuator 230, energy couplers 240 (where the energy couplers 240 include an input energy coupler 240-1 and an output energy coupler 240-2), a magnetic focus system 250, and a collector 260.

Specifically, the electron gun 210 is configured to generate an electron beam that meets a design requirement, and may be a Pierce parallel flow electron gun, a Pierce convergence electron gun, a high-perveance electron gun, an anode-controlled electron gun, a grid-controlled electron gun, a non-intercepting grid-controlled electron gun, a low-noise electron gun, or the like. The slow-wave circuit 220 is configured to reduce a phase velocity of an electromagnetic wave, so that the electromagnetic wave exchanges energy with the electron beam. The attenuator 230 is configured to eliminate oscillations caused by poor impedance matching between the energy coupler 240 and the slow-wave circuit 220. The magnetic focus system 250 is configured to keep the electron beam generated by the electron gun 210 in a required shape, ensure that the electron beam can smoothly pass through the slow-wave circuit 220, and enable the electron beam to exchange energy effectively with the electromagnetic wave. The collector 260 is configured to receive an electron beam that has exchanged energy with the electromagnetic wave. A to-be-amplified signal enters the slow-wave circuit 220 through the energy coupler 240 (or the input energy coupler 240-1), and travels along the slow-wave circuit 220. An amplified signal is sent to a load through the energy coupler 240 (or the output energy coupler 240-2).

It can be learned from FIG. 2 that, the input energy coupler 240-1 (which may be understood as a high-frequency signal input system) and the electron gun 210 are designed independently, and are separately equipped and then assembled through welding and packaging. As a result, a size of the traveling wave tube 200 is large, an assembly error is large, and energy exchange efficiency between a high-frequency circuit (which may be understood as the slow-wave circuit 220) and the electron beam is low. This not conducive to miniaturization, integration, and an integrated design and manufacturing of the traveling wave tube 200.

Specifically, because the electron gun 210 is separated from the input energy coupler 240-1, to obtain a well-clustered electron beam, a longer high-frequency circuit needs to be used to complete energy exchange with a direct current electron beam emitted from the electron gun 210. As a result, the traveling wave tube 200 needs the longer high-frequency circuit to implement velocity modulation for the electron beam, causing a large overall size of the traveling wave tube 200, and low energy exchange efficiency between the high-frequency circuit and the electron beam. This is not conducive to miniaturization development of a vacuum electronic device such as the traveling wave tube 200.

In view of the foregoing technical problem, this disclosure provides an electron gun and a vacuum electronic device. An anode of the electron gun and a signal input system are integrated together, so that an integrated design and processing and manufacturing of the electron gun and the signal input system can be implemented. In addition, because an integrated design form of the electron gun and the signal input system is used, in this disclosure, a length of a circuit in which energy exchange occurs between an electron beam and a high-frequency circuit can be reduced, and energy exchange efficiency between the electron beam and the high-frequency circuit can be improved.

The foregoing signal input system may include a high-frequency signal input system, or may include a low-frequency signal input system. In embodiments of this disclosure, the high-frequency signal input system is used as an example for description.

The following further describes the electron gun in embodiments of this disclosure with reference to FIG. 3.

FIG. 3 is a diagram of a structure of an electron gun 300 according to an embodiment of this disclosure. It should be noted that, the structure of the electron gun 300 shown in FIG. 3 is only a part of a complete structure of the electron gun 300, but not an entire structure of the electron gun 300. As shown in FIG. 3, the electron gun 300 includes: A cathode 31, a focus electrode 32, and an energy exchange module 33.

The energy exchange module 33 includes an anode port 331, a signal input port 332, and an energy exchange unit 333.

Specifically, the cathode 31 is configured to emit electrons. The focus electrode 32 can control a current loaded at the cathode 31, and converge electrons emitted from a surface of the cathode 31 into an electron beam. A material of the cathode 31 includes but is not limited to: a hot cathode, a cold cathode, a plasma cathode, a photocathode, or the like. A shape of the cathode 31 includes, but is not limited to: a circle, a rectangle, an ellipse, a ring, or another shape. The material and the shape of the cathode 31 are not limited in embodiments of this disclosure, and may be designed and selected based on an actual requirement of a device.

A voltage loaded on the anode port 331 can accelerate forward transmission of the electrons emitted from the surface of the cathode 31. In other words, the electron beam is generated by the cathode 31, the focus electrode 32, and the anode port 331. The signal input port 332 is configured to input a signal (for example, a high-frequency signal). In other words, the input signal may be input into the energy exchange unit 333 of the energy exchange module 33 through the signal input port 332, and an electromagnetic field is excited in the energy exchange unit 333 (for example, when the input signal is the high-frequency signal, a high-frequency electromagnetic field can be excited). The electron beam passing through the anode port 331 is subject to velocity modulation in the electromagnetic field excited by the input signal in the energy exchange unit 333. After the velocity modulation of the energy exchange unit 333, a velocity of the electron beam changes. After traveling for a specific distance, a density-modulated electron beam may be generated, and finally a modulated current carrying input signal information may be obtained. In other words, an energy exchange process is completed between the electron beam and the input signal in the energy exchange unit 333, and a pre-modulated electron beam is obtained.

In some embodiments, the anode port 331, the signal input port 332, and the energy exchange unit 333 are integrally processed and molded. To be specific, for example, the energy exchange unit 333 is a framework, and the anode port 331 and the signal input port 332 are provided on or integrated into or integrally formed with the energy exchange unit 333. For details, refer to an example structure shown in FIG. 3.

A shape of the anode port 331 may include a circular tube head, an elliptic tube head, a rectangular tube head, or the like. The anode port 331 may be provided on one side of the energy exchange unit 333 shown in FIG. 3.

In addition, the signal input port 332 may be a hole structure of the energy exchange unit 333, and the input signal may be input into the energy exchange unit 333 from the hole structure of the energy exchange unit 333.

In some embodiments, the energy exchange unit 333 is a resonant cavity. The resonant cavity may also be understood as a resonator.

Optionally, the resonant cavity may include at least two resonant sub-cavities. When there is only one resonant sub-cavity, the resonant sub-cavity may also be understood as the resonant cavity.

Optionally, the resonant cavity may further include a slow-wave circuit. Slow-wave circuits may include a high-frequency slow-wave circuit and a low-frequency slow-wave circuit. A type of the slow-wave circuit is not limited in embodiments of this disclosure. For details, refer to the following descriptions.

In some embodiments, when the energy exchange unit 333 is a resonant cavity, the anode port 331 may be an opening provided on one side of the resonant cavity, and the electron beam is transmitted from the opening to the energy exchange unit 333. The signal input port 332 may be a hole in an upper part of the resonant cavity, and the input signal is input into the energy exchange unit 333 from the hole. For details, refer to the example structure shown in FIG. 3.

In some embodiments, the energy exchange unit 333 may include the resonant cavity or the slow-wave circuit. The resonant cavity or the slow-wave circuit may be configured to generate an axial electromagnetic field, and the axial electromagnetic field may be used to complete velocity modulation for the electron beam.

Specifically, the energy exchange unit 333 can be configured to enable a signal (for example, a high-frequency signal) input from the signal input port 332 to complete an energy exchange process with an electron emitted from the surface of the cathode 31.

In some embodiments, the signal input port 332 includes a waveguide port, for example, a rectangular waveguide port, a circular waveguide port, or a coaxial waveguide port.

Optionally, there is a gap between the focus electrode 32 and the cathode 31, so that a potential difference may be formed between the focus electrode 32 and the cathode 31. There is a gap between the focus electrode 32 and the anode port 331, so that a potential difference may be formed between the focus electrode 32 and the anode port 331.

In some embodiments, the electron gun 300 may further include a cathode base, an insulating sleeve, and a support rod.

Specifically, in addition to being configured to fasten the cathode 31, the cathode base may be further configured to connect to an external power supply and be sealed and welded with the insulating sleeve. Two ends of the support rod are respectively connected to the insulating sleeve and the focus electrode 32, to support and fasten the focus electrode 32. The support rod is welded and sealed with the insulating sleeve. The support rod is connected to the external power supply, and supplies power to the focus electrode 32. The insulating sleeve is welded together with a housing of the energy exchange module 33.

Optionally, the focus electrode 32 and the support rod may be made of a metal material, for example, non-magnetic stainless steel or copper. A material of the insulating sleeve may be ceramic or the like.

In the diagram of the structure shown in FIG. 3, an operating principle of the electron gun 300 is as follows:

During operation, electrons emitted from the surface of the cathode 31 are converged into an electron beam under action of the focus electrode 32. Forward transmission of the electron beam is accelerated under action of the voltage loaded on the anode port 331. An input signal is input from the signal input port 332 into the energy exchange unit 333, and an electromagnetic field is excited in the energy exchange unit 333. The electron beam passing through the anode port 331 is subject to velocity modulation in the electromagnetic field in the energy exchange unit 333. After passing through the energy exchange unit 333, a velocity of the electron beam changes. After traveling for a specific distance, a density-modulated electron beam may be generated, and finally a modulated current carrying input signal information is obtained. In other words, an energy exchange process is completed between the electron beam and the input signal in the energy exchange unit 333, and a pre-modulated electron beam may be obtained.

In some embodiments, the anode port 331, the signal input port 332, and the energy exchange unit 333 are made of a same material. In this way, integrated processing and molding of the anode port 331, the signal input port 332, and the energy exchange unit 333 can be implemented, so that processing steps and an assembly error are reduced, and the structure is more compact.

In some embodiments, the energy exchange unit 333 is made of silver/copper; or an inner wall of the energy exchange unit 333 is plated with silver/copper.

In some embodiments, the anode port 331 is made of silver/copper; or a surface of the anode port 331 is plated with silver, copper, or molybdenum.

Optionally, in this disclosure, the energy exchange unit 333 can be processed by using a plurality of materials. For example, the energy exchange unit 333 is first printed by using a ceramic material, and then a metal material, for example, silver/copper, is plated on a surface of the ceramic material. The energy exchange unit 333 may be plated with silver or copper inside. An inner wall of the anode port 331 may also be plated with copper/silver. An outer surface of the anode port 331 may also be made of a ceramic material.

The anode and the signal input port (where the signal input port may be understood as a signal input system) of the electron gun are integrated together (for example, into the energy exchange module 33), so that an integrated design and processing and manufacturing of the electron gun and the signal input system can be implemented. In addition, because an integrated design form of the electron gun and the signal input system is used, in this disclosure, a distance over which energy exchange occurs between the electron beam and the high-frequency circuit can be reduced, and energy exchange efficiency between the electron beam and the high-frequency circuit can be improved.

In addition, in this disclosure, the velocity modulation for the electron beam is implemented by using the electromagnetic field generated by the input signal in the energy exchange unit 333. For example, the cathode 31 first emits electrons, the focus electrode 32 then converges the electrons into an electron beam, and the electron beam passes through the energy exchange unit 333 under action of the anode port 331, to implement velocity modulation and obtain a pre-modulated electron beam. In this way, an operating frequency band of the electron gun in this embodiment of this disclosure is wide, and the electron gun can operate in a frequency band between a megahertz band and a terahertz band, to operate in a wide frequency band.

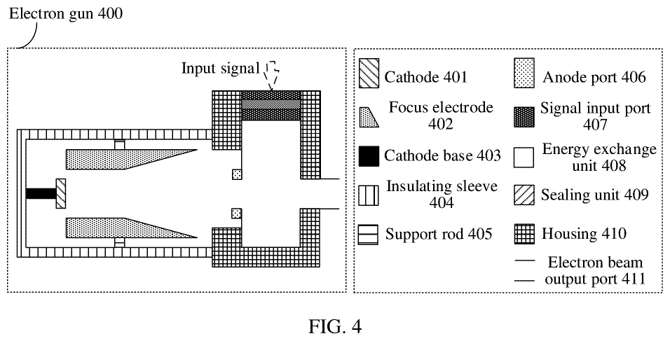

The following further describes the electron gun 300 shown in FIG. 3 with reference to FIG. 4 to FIG. 6.

FIG. 4 is a diagram of a structure of an electron gun 400 according to an embodiment of this disclosure. It should be noted that, the structure of the electron gun 400 shown in FIG. 4 is only a part of a complete structure of the electron gun 400, but not an entire structure of the electron gun 400. As shown in FIG. 4, the electron gun 400 includes:

a cathode 401, a focus electrode 402, a cathode base 403, an insulating sleeve 404, a support rod 405, an anode port 406, a signal input port 407, an energy exchange unit 408, a sealing unit 409, and a housing 410.

For descriptions of the cathode 401, the focus electrode 402, the cathode base 403, the insulating sleeve 404, the support rod 405, the anode port 406, the signal input port 407, and the energy exchange unit 408, refer to the foregoing content. Details are not described herein again.

Specifically, the sealing unit 409 may use a structure of a sealing window, and the sealing unit 409 is configured to be welded to the housing 410 for sealing, to ensure vacuum sealing of the electron gun 400, and further ensure that an input signal can be input into the energy exchange unit 408. A material of the sealing window piece may include ceramic, sapphire, diamond, or the like.

Optionally, the sealing unit 409 is disposed on the signal input port 407. For details, refer to an example structure shown in FIG. 4.

Optionally, a material of the housing 410 may include oxygen-free copper. The housing 410 and the insulating sleeve 404 are welded together.

In some embodiments, the electron gun 400 may further include an electron beam output port 411. The electron beam output port 411 is configured to provide a channel for transmission of the electron beam, and also facilitates welding and packaging with a high-frequency circuit at a back end. The electron beam output port 411 may be provided on the energy exchange unit 408. For details, refer to the example structure shown in FIG. 4.

Optionally, the cathode 401, the focus electrode 402, the anode port 406, the energy exchange unit 408, and the electron beam output port 411 may be installed in a concentric installation manner. This can ensure a concentricity of the electron gun 400, so that the electron beam can be transmitted in an axial direction.

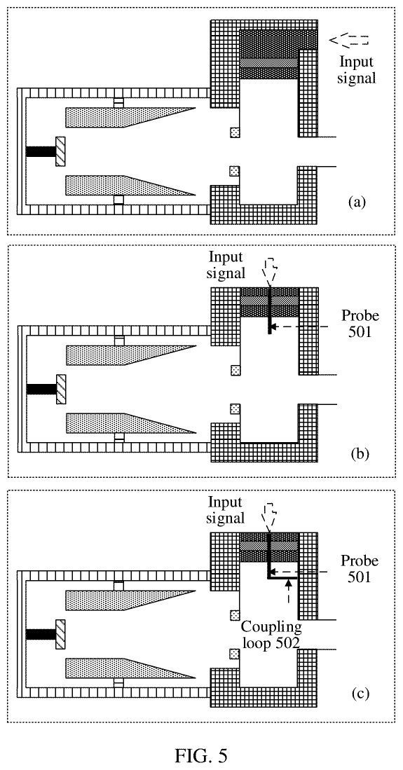

FIG. 5 is a diagram of a structure of a signal input port 500 according to an embodiment of this disclosure. Specifically, (a) of FIG. 5 shows a signal input port 500 parallel to a transmission direction of an electron beam. A port direction of the signal input port 500 is parallel to the transmission direction of the electron beam, and the port direction may be left or right.

(b) of FIG. 5 shows a signal input port 500 that is perpendicular to a transmission direction of an electron beam and that has a probe 501. The probe 501 may extend into the energy exchange unit 333/408, and excite an electromagnetic field in the energy exchange unit 333/408. The probe 501 and the sealing unit 409 are kept welded and sealed. In addition, the probe 501 extends into the energy exchange unit 333/408 from the signal input port 407. A length at which the probe 501 extends into the energy exchange unit 408 from the signal input port 407 is determined based on the energy exchange unit 333/408. For example, the probe is inserted in a direction parallel to a power line of a high-frequency electric field. Preferably, the probe should be located at a position in which a high-frequency electric field is concentrated in a circuit. This needs to be specifically determined based on an operating mode of the circuit.

The probe 501 extends from the sealing unit 409 to the energy exchange unit 333/408.

Optionally, a length at which the probe 501 extends into the energy exchange unit 333/408 may be measured based on a distance between a tip of the probe 501 and the sealing unit 409. The probe 501 can be configured to enable an electric field to induce a high-frequency potential as high as possible on the probe, to enhance a modulation capability for the electron beam.

The probe is used to achieve a more compact structure and a smaller size. A probe-based coupling is an electrical coupling. The probe is inserted into a resonant cavity in a direction parallel to a power line of a high-frequency electric field, so that an electric field induces a high-frequency potential as high as possible on the probe, to enhance the modulation capability for the electron beam.

(c) of FIG. 5 shows a signal input port 500 that is perpendicular to a transmission direction of an electron beam and whose probe 501 is connected to the energy exchange unit 333/408 by using a coupling loop 502. The probe 501 is connected to the energy exchange unit 333/408 by using the coupling loop 502, so that a coupling loop circuit may be formed. The coupling loop 502 and a sealing window are welded and sealed. In addition, the coupling loop 502 is separately connected to the probe 501 and the energy exchange unit 333/408.

The coupling loop 502 may be of a ring structure, or may be of an L-shaped structure formed by bending the probe 501. A specific structure of the coupling loop 502 is not limited in embodiments of this disclosure. The coupling loop 502 can be configured to enable as many magnetic lines as possible to pass through the coupling loop, to induce a high-frequency current. The coupling loop 502 is magnetically coupled, and a plane of the coupling loop 502 is perpendicular to a magnetic line of a high-frequency electromagnetic field, so that as many magnetic lines as possible pass through the coupling loop 502, to induce a high-frequency current.

It may be understood that, placement positions and directions of the probe 501 and the coupling loop 502 are related to a specific circuit, and the positions and the directions of the probe 501 and the coupling loop 502 need to be determined based on directions of a high-frequency electric field and a high-frequency magnetic field in the high-frequency circuit.

It may be understood that the signal input port 500 may be a signal input port 332/407.

In this embodiment of this disclosure, the probe and the coupling loop in (b) and (c) of FIG. 5 may alternatively be integrated into the structure shown in (a) of FIG. 5. The probe 501 and the coupling loop 502 are made of a same material.

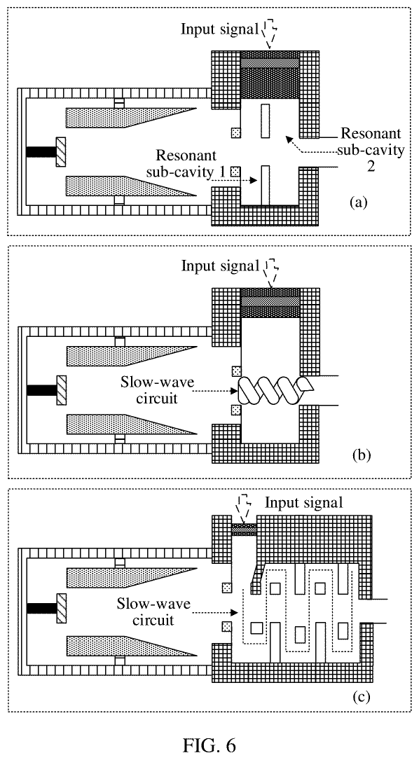

FIG. 6 is a diagram of a structure of an energy exchange unit 600 according to an embodiment of this disclosure. As shown in FIG. 6, (a) of FIG. 6 shows an energy exchange unit 600 that uses two resonant sub-cavities. A spacing (for example, two white rectangles in FIG. 6) for separating the resonant sub-cavities may be made of a metal material, or may be made of another material.

In this embodiment of this disclosure, a quantity of resonant sub-cavities in a resonant cavity is related to an operating bandwidth of the electron gun 300/400. For example, to extend the operating bandwidth of the electron gun 300/400, the energy exchange unit 600 may select the quantity of resonant sub-cavities based on a requirement. For example, a larger quantity of resonant sub-cavities indicates a wider operating bandwidth of the electron gun 300/400. This is because a bandwidth of the resonant cavity can be increased by reducing a quality factor of the resonant cavity.

It may be understood that the resonant cavity in this embodiment of this disclosure may include a rectangular resonant cavity, a cylindrical resonant cavity, or the like. A specific form of the resonant cavity is not limited in embodiments of this disclosure. In the resonant cavity, an electromagnetic field may oscillate at a series of frequencies, and a frequency of the resonant cavity is related to a shape, a geometric size, and a resonant wave form of the resonant cavity.

(b) of FIG. 6 shows an energy exchange unit 600 using a slow-wave circuit. The slow-wave circuit shown in (b) of FIG. 6 is of a spiral line structure. The slow-wave circuit may further include a coupled cavity structure. In addition, the spiral line structure may further include a structure such as a spiral line, an annular rod line, or annular circle line. The coupled cavity structure may further include a Hughes circuit, a clover leaf-shaped circuit, or the like. The slow-wave circuit may further include an interdigital slow-wave line, a curved line, a Cape line, or the like. The slow-wave circuit shown in (b) of FIG. 6 may be installed in a resonant cavity.

In this disclosure, a specific type of the slow-wave circuit can be selected based on a bandwidth of a component. In addition, a larger modulation current may be obtained by increasing a length of the slow-wave circuit. A specific structure of a slow-wave circuit structure is not limited in embodiments of this disclosure.

(c) of FIG. 6 shows an energy exchange unit 600 using a slow-wave circuit. A black dashed line shown in (c) in FIG. 6 is used to identify a slow-wave circuit, and the slow-wave circuit may be installed in a metal slot in the housing. In addition, a white box within the black dotted line identifies a metal protrusion. It can be learned from (c) of FIG. 6 that the slow wave circuit may not be installed in the resonant cavity. That is, the energy exchange unit 333/408 is a slow-wave circuit.

It may be understood that the energy exchange unit 600 shown in FIG. 6 may be combined with the signal input port 500 shown in FIG. 5, that is, a plurality of combination manners may be formed based on FIG. 6 and FIG. 5.

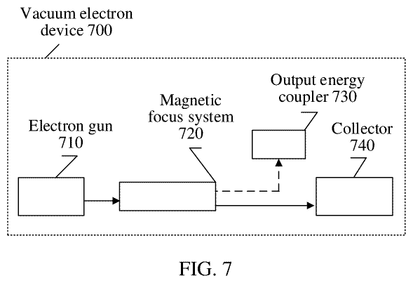

FIG. 7 is a diagram of a structure of a vacuum electronic device 700 according to an embodiment of this disclosure. As shown in FIG. 7, the vacuum electronic device includes an electron gun 710. The electron gun 710 may be the electron gun 300, or may be the electron gun 400.

In some embodiments, the vacuum electronic device may further include a magnetic focus system 720, an output energy coupler 730, and a collector 740.

In some embodiments, the vacuum electronic device 700 may further include an attenuator.

Optionally, the vacuum electronic device 700 may be used as a power amplifier, or may be used as an oscillator. The vacuum electronic device 700 may determine different units or compositions based on different application types. For example, when the vacuum electronic device 700 is used as an oscillator, the vacuum electronic device 700 may not include an attenuator.

In this embodiment of this disclosure, application fields of the vacuum electronic device 700 may include: broadcasting (e.g., an application such as a radio, a television, and live satellite broadcast), telecommunication (e.g., an application such as a point-to-point link, satellite communication, and deep space communication), civil radars (such as an airborne radar, a weather radar, and an air traffic control radar), industrial application (e.g., industrial heating and a home microwave oven), and scientific application (such as a scientific particle accelerator and a civil accelerator).

A person of ordinary skill in the art may be aware that, in combination with the examples described in embodiments disclosed in this specification, units and algorithm steps can be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this disclosure.

In the several embodiments provided in this disclosure, it should be understood that the disclosed apparatus may be implemented in other manners. For example, the described apparatus embodiment is merely an example. For example, division into the units is merely logical function division and may be other division during actual implementation. For example, a plurality of units or components may be combined or integrated into another system, or some features may be ignored or not performed.

In addition, the displayed or discussed mutual couplings or direct couplings may be implemented through some interfaces. The indirect couplings between the apparatuses or the units may be implemented in electronic, mechanical, or other forms.

The units described as separate parts may or may not be physically separate, and parts displayed as units may or may not be physical units, in other words, may be located at one position, or may be distributed on a plurality of network units. Some or all of the units may be selected based on actual requirements to achieve the objectives of the solutions of embodiments.

In addition, functional units in embodiments of this disclosure may be integrated into one processing unit, each of the units may exist alone physically, or two or more units may be integrated into one unit.

The foregoing descriptions are merely specific implementations of this disclosure, but are not intended to limit the protection scope of this disclosure. Any variation or replacement readily figured out by a person skilled in the art within the technical scope disclosed in this disclosure shall fall within the protection scope of this disclosure. Therefore, the protection scope of this disclosure shall be subject to the protection scope of the claims.

What is claimed is:

1. An electron gun, comprising:
a cathode, a focus electrode, and an energy exchange module,
wherein the energy exchange module comprises an anode port, a signal input port, and an energy exchange unit;
an input signal is input from the signal input port of the energy exchange module into the energy exchange unit of the energy exchange module, and wherein energy exchange with the input signal is performed by transmitting an electron beam from the anode port of the energy exchange module to the energy exchange unit of the energy exchange module; and
the electron beam is generated by the cathode, the focus electrode, and the anode port.

2. The electron gun according to claim 1, wherein the energy exchange unit comprises a resonant cavity.

3. The electron gun according to claim 1, wherein the energy exchange unit comprises at least one of:
a slow-wave circuit, or
at least two resonant sub-cavities.

4. The electron gun according to claim 1, further comprising:
a probe, wherein the probe extends into the energy exchange unit from the signal input port.

5. The electron gun according to claim 4, wherein a length at which the probe extends into the energy exchange unit from the signal input port is based on the energy exchange unit.

6. The electron gun according to claim 4, further comprising:
a coupling loop, wherein the coupling loop is separately in contact with each of the probe and the energy exchange unit.

7. The electron gun according to claim 6, wherein the probe and the coupling loop are made of a same material.

8. The electron gun according to claim 1, further comprising:
a cathode base, an insulating sleeve, and a support rod,
wherein the support rod is configured to connect the focus electrode to the insulating sleeve; and
the cathode base is connected to the insulating sleeve.

9. The electron gun according to claim 1, further comprising:
an electron beam output port, wherein the electron beam output port is provided on the energy exchange unit.

10. The electron gun according to claim 4, further comprising:
a sealing unit on the signal input port, wherein the probe extends from the sealing unit into the energy exchange unit.

11. The electron gun according to claim 1, wherein the anode port, the signal input port, and the energy exchange unit are made of a same material.

12. The electron gun according to claim 1, wherein the anode port, the signal input port, and the energy exchange unit are integrated into a same assembly.

13. The electron gun according to claim 11, wherein the energy exchange unit is made of one or more of silver or copper; or
an inner wall of the energy exchange unit is plated with one or more of silver or copper.

14. The electron gun according to claim 11, wherein the anode port is made of one or more of silver or copper; or
a surface of the anode port is plated with one or more of silver, copper, or molybdenum.

15. A vacuum electronic device comprising an electron gun, wherein the electron gun comprises:
a cathode, a focus electrode, and an energy exchange module,
wherein the energy exchange module comprises an anode port, a signal input port, and an energy exchange unit;
an input signal is input from the signal input port of the energy exchange module into the energy exchange unit of the energy exchange module, and wherein energy exchange with the input signal is performed by transmitting an electron beam is transmitted from the anode port of the energy exchange module to the energy exchange unit of the energy exchange module; and
the electron beam is generated by the cathode, the focus electrode, and the anode port.

16. The vacuum electronic device according to claim 15, further comprising a magnetic focus system, a collector, and an output energy coupler.

17. The vacuum electronic device according to claim 16, further comprising an attenuator.

18. The vacuum electronic device according to claim 15, wherein the energy exchange unit comprises a resonant cavity.

19. The vacuum electronic device according to claim 15, wherein the energy exchange unit comprises at least one of:
a slow-wave circuit, or
at least two resonant sub-cavities.

20. The vacuum electronic device according to claim 15, wherein the electron gun further comprises a probe, wherein the probe extends into the energy exchange unit from the signal input port.

21. The vacuum electronic device according to claim 20, wherein a length at which the probe extends into the energy exchange unit from the signal input port is based on the energy exchange unit.

22. The vacuum electronic device according to claim 20, wherein the electron gun further comprises a coupling loop, wherein the coupling loop is separately in contact with each of the probe and the energy exchange unit.

23. The vacuum electronic device according to claim 22, wherein the probe and the coupling loop are made of a same material.

24. The vacuum electronic device according to claim 15, wherein the electron gun further comprises a cathode base, an insulating sleeve, and a support rod,
wherein the support rod is configured to connect the focus electrode to the insulating sleeve; and
the cathode base is connected to the insulating sleeve.

25. The vacuum electronic device according to claim 15, wherein the electron gun further comprises an electron beam output port, wherein the electron beam output port is provided on the energy exchange unit.

26. The vacuum electronic device according to claim 20, wherein the electron gun further comprises a sealing unit on the signal input port, wherein the probe extends from the sealing unit into the energy exchange unit.

27. The vacuum electronic device according to claim 15, wherein the anode port, the signal input port, and the energy exchange unit are made of a same material.

28. The vacuum electronic device according to claim 15, wherein the anode port, the signal input port, and the energy exchange unit are integrated into a same assembly.

29. An electronic system comprising a vacuum electronic device including an electron gun, wherein the electron gun comprises:
a cathode, a focus electrode, and an energy exchange module,
wherein the energy exchange module comprises an anode port, a signal input port, and an energy exchange unit;
an input signal is input from the signal input port of the energy exchange module into the energy exchange unit of the energy exchange module, and wherein energy exchange with the input signal is performed by transmitting an electron beam from the anode port of the energy exchange module to the energy exchange unit of the energy exchange module; and
the electron beam is generated by the cathode, the focus electrode, and the anode port.

30. The electronic system according to claim 29, wherein the energy exchange unit comprises a resonant cavity.
